(19) United States
(12) Patent Application Publication
(10) Pub. No.: US 2006/0215837 A1
(43) Pub. Date: Sep. 28, 2006

(54) Method and apparatus for generating an identifier-based public/private key pair

(75) Inventors: Liqun Chen, Bristol (GB); Keith Alexander Harrison, Chepstow (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/305,869

(22) Filed: Dec. 16, 2005

(30) Foreign Application Priority Data
Dec. 18, 2004 (GB) 0427795.0
Sep. 1, 2005 (GB) 0517700.1

(51) Int. Cl. H04L 9/00

(52) U.S. Cl. 380/44

(57) ABSTRACT

An identifier-based public/private key pair is generated for a first party with the involvement of a trusted authority that has an associated secret. An identifier of the first party is signed by the trusted party to produce a multi-component signature. This signature is converted into the first-party identifier-based key pair; the private key of this key pair comprises a component of the signature provided confidentially to the first party, and the public key being formed using at least another component of the signature and the first-party identifier. The signature used by the trusted authority is, for example, a Schnorr signature or a DSA signature.

### FIELD OF THE INVENTION

The present invention relates to a method and apparatus for generating an identifier-based public/private cryptographic key pair; the present invention also relates to the use of a key pair so generated in the provision of various cryptographic services where the identity of the holder of the private key is an issue.

### BACKGROUND OF THE INVENTION

One well known approach to providing party authentication is to use a public key infrastructure where each party has an associated public/private key-pair. More particularly, assuming that a party A has an associated public/private key-pair for which party A holds the private key, another party B can use A's public key to send a message in confidence to A, to verify a digital signature applied by A to a message using her private key, and to effect on-line authentication of party A by a challenge/response protocol. Such a system relies on party B trusting the association between the public key and A and this is achieved by the use of a digital certificate issued and signed by a certification authority using its own public key. Of course, for B to trust the certificate, B must trust the association of the public key used to sign the certificate with the certification authority; this association may therefore itself be subject of a further certificate issued by a higher certification authority and so on up a hierarchy of certification authorities until a root authority is reached. The infrastructure established by the hierarchy of certification authorities is referred to as a public key infrastructure, often abbreviated to “PKI”. In fact, a PKI will generally also take care of key management issues such as generating and distributing new keys, and revoking out-of-date keys.

Disadvantages of the foregoing approach to party authentication are the requirement for an infrastructure with which the parties are already registered and which must hold data about each registered party, and the need to use and manage certificates.

A different approach to enabling party authentication is identifier-based cryptography. As is well known to persons skilled in the art, in “identifier-based” cryptographic methods a public, cryptographically unconstrained, string is used in conjunction with public data of a trusted authority to carry out tasks such as data encryption and signature verification. The complementary tasks, such as decryption and signing, require the involvement of the trusted authority to carry out computation based on the public string and its own private data. In fact, the public string can be considered as a public key (or, more generally, as a defining element of a public key that includes one or more other public elements); the trusted authority uses the public string together with its own private data, to derive a private key that compliments the public key. Thus a message encrypted using the public string can be decrypted using the private key generated by the trusted authority, and a signature generated using the private key can be verified using the public string.

In message-signing applications and frequently also in message encryption applications, the public string serves to “identify” a party (the sender in signing applications, the intended recipient in encryption applications); this has given rise to the use of the label “identifier-based” or “identity-based” generally for these cryptographic methods and public strings concerned. The trusted authority, before providing a party with the private key complimenting the “identifier-based” public string (or “identifier”), is generally required to check that the party concerned is entitled to the “identity” constituted by the IB public string.

A number of identifier-based (“IB”) cryptographic methodologies are known, including:
methods based on “Quadratic Residuosity” as described in the paper: “An identity based encryption scheme based on quadratic residues”, C. Cocks, Proceedings of the 8^{th} IMA International Conference on Cryptography and Coding, LNCS 2260, pp 360-363, Springer-Verlag, 2001;
methods using Weil or Tate pairings—see, for example: D. Boneh, M. Franklin—“Identity-based Encryption from the Weil Pairing” in Advances in Cryptology-CRYPTO 2001, LNCS 2139, pp. 213-229, Springer-Verlag, 2001;
methods based on mediated RSA as described in the paper “Identity based encryption using mediated RSA”, D. Boneh, X. Ding and G. Tsudik, 3rd Workshop on Information Security Application, Jeju Island, Korea, August, 2002.

The manner in which an identifier-based public/private key pair is generated from an identifier string depends on the particular IB cryptographic methodology being used.

Pairings-based cryptographic methodologies provide a conceptually simple way of converting an identifier IDA to a key pair for a party A; in this case (and assuming an implementation based on elliptic curves), a trusted authority with secret s and public points P and R (=sP), signs the identifier IDA by multiplying a point derived from the identifier IDA by s to produce a new point S_{ID} that forms the private key of party A. Unfortunately. pairings-based methodologies are generally computationally demanding. Furthermore, other IB methodologies do not provide corresponding ways of generating an IB key pair based on the trusted authority signing a party identifier.

It is an object of the present invention to provide an IB key pair generation method and apparatus that does not rely on a pairings-based IB methodology.

### SUMMARY OF THE INVENTION

According to one aspect of the present invention, there is provided a method of generating an identifier-based public/private key pair for a first party, comprising:
providing an identifier of the first party for use by a first trusted entity that has a secret the first trusted entity using its secret to compute a multi-component signature, based on discrete logarithms, over the first-party identifier; and
converting the signature into the first-party identifier-based key pair, the private key of this key pair comprising a first component of the signature provided confidentially to the first party, and the public key being formed using at least another component of the signature and said identifier.

According to another aspect of the present invention, there is provided apparatus for of generating an identifier-based public/private key pair for a first party, comprising:
a first computing arrangement associated with a trusted authority that has associated public values g, p, q, y and secret x where:
   p and q are large primes satisfying q|p−1;
   g is an integer such that g^{q}=1 mod p;
   x is an integer such that 1<x<q; and
   y=g^{x} mod p;
the first computing arrangement being arranged to use the secret x to compute a multi-component signature over an identifier of a first party; and
a second computing arrangement arranged to convert the signature into the first-party identifier-based key pair, the private key of this key pair comprising a first component of the signature provided as a secret to the first party, and the public key being formed using at least another component of the signature and said identifier.

### BRIEF DESCRIPTION OF THE DRAWINGS

Embodiments of the invention will now be described, by way of non-limiting example, with reference to the accompanying diagrammatic drawings, in which:

FIG. 1 is a diagram illustrating the generation of an identifier-based public/private key pair according to a first embodiment of the invention;

FIG. 2 is a diagram illustrating the generation of an identifier-based public/private key pair according to a second embodiment of the invention;

FIG. 3 is a diagram illustrating an example signature usage of a key pair generated according to FIG. 1;

FIG. 4 is a diagram illustrating an example signature usage of a key pair generated according to FIG. 2;

FIG. 5 is a diagram illustrating an example authentication usage of a key pair generated according to FIG. 1;

FIG. 6 is a diagram illustrating an example authentication usage of a key pair generated according to FIG. 2;

FIG. 7 is a diagram illustrating an example key-distribution usage of a key pair generated according to FIG. 1, this example usage employing first and second trusted authorities with the same public system parameters;

FIG. 8 is a diagram illustrating an example key-distribution usage of a key pair generated according to FIG. 2, this example usage employing first and second trusted authorities with the same public system parameters;

FIG. 9 is a diagram illustrating an example key-distribution usage of a key pair generated according to FIG. 1, this example usage employing first and second trusted authorities with different public system parameters; and

FIG. 10 is a diagram illustrating an example two-party key-agreement usage of key pairs generated according to FIG. 1, this example usage employing first and second trusted authorities with the same public system parameters.

### BEST MODE OF CARRYING OUT THE INVENTION

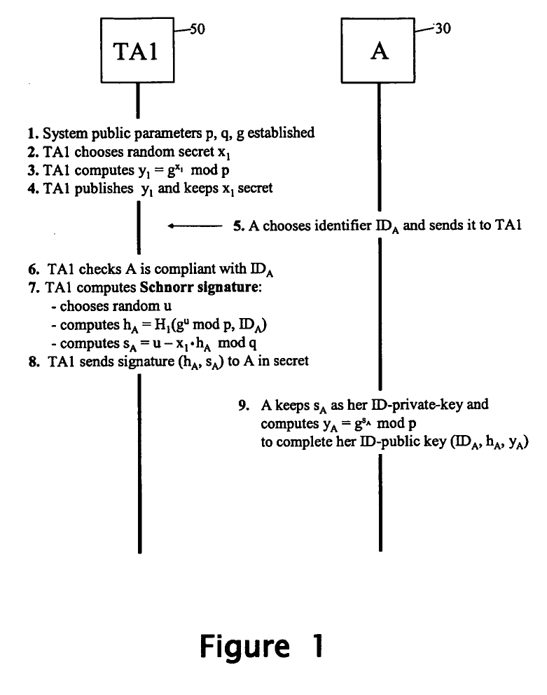

The example cryptographic methods and apparatus described below with respect to FIGS. 1 to 10 involve two, three or four parties depending on the particular example concerned, these parties being a first user A acting through computing entity 30, a second user B acting through computing entity 40, a first trusted authority TA1 acting through computing entity 50, and a second trusted authority TA2 acting through computing entity 60. The computing entities 30, 40, 50 and 60 are typically based around program-controlled processors though some or all of the cryptographic functions may be implemented in dedicated hardware. The entities 30, 40, 50 and 60 inter-communicate, for example, via the internet or other computer network though it is also possible that two, three or all four entities actually reside on the same computing platform. It would alternatively be possible for some or all of the communication between the entities 30, 40, 50 and 60 to effected by the physical transport of data storage media. The term “computing entity” encompasses any apparatus with appropriate computing functionality and includes, for example, mobile phone apparatus provided such apparatus is capable of carrying out the required computations. A computing entity can be constituted by a functional combination of more than one physical item.

For convenience, the following description is given in terms of the parties A, B, TA1 and TA2, as appropriate, it being understood that these parties act through their respective computing entities.

The embodiments and usage examples of the invention to be described hereinafter are based on the discrete logarithm problem, that is, given a prime p and values g and y, then for large values of p (for example, around 100 decimal digits or greater) it is computationally infeasible to find a value of x such that:
y=g^{x} mod p
Example cryptographic techniques based on the discrete logarithm problem include the Diffie-Hellman key exchange algorithm. For this algorithm, public system parameters p, q and g are defined; when parties A and B with respective secrets x_{A} and x_{B} wish to share a symmetric key, each sends the other the public parameter g raised to the power of its respective secret. Thus, A sends B g^{x}^{_{A}} mod p, and B sends A g^{x}^{_{B}} mod p. The receiving party then raises the received value to the power of its own secret so that each ends up with the value g^{x}^{_{A}}^{x}^{_{B}} mod p which can be used as a symmetric key. A key formed in this way is referred to herein as a Diffie-Hellman or DH key.

In all the embodiments described below, the user party A generates an identifier-based public/private key pair (asymmetric key pair) using components of a signature over an identifier ID_{A} of party A, this signature being produced by the trusted authority TA1 and being provided to the party A in a secure manner. By way of example, the use of two different types of signature by the trusted authority TA1 are described, namely Schnorr signatures and DSA signatures; other signature types can also be used. Schnorr signatures are described, for example, in U.S. Pat. No. 4,995,082. DSA signatures are described, for example, in the US Federal Information Processing Standards document FIPS 186-2.

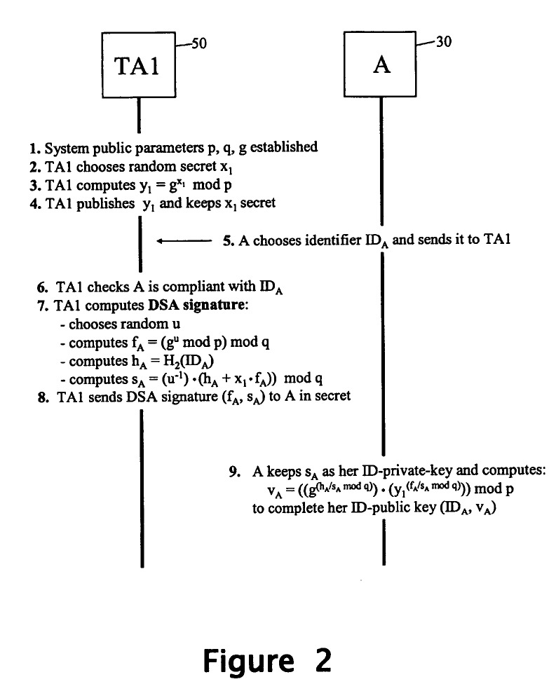

More specifically, FIGS. 1 and 2 and the related description respectively concern the generation of a public/private key pair by party A on the basis of a Schnorr signature over party A's identifier ID_{A}, and the generation of a public/private key pair by party A on the basis of a DSA signature over party A's identifier ID_{A}.

In all cases, the public key of the key pair includes an identifier ID_{A} of the party A. Due to the manner in which the key pair is generated, it becomes possible to directly or indirectly verify that the party holding the private key is validly associated with the identity ID_{A}.

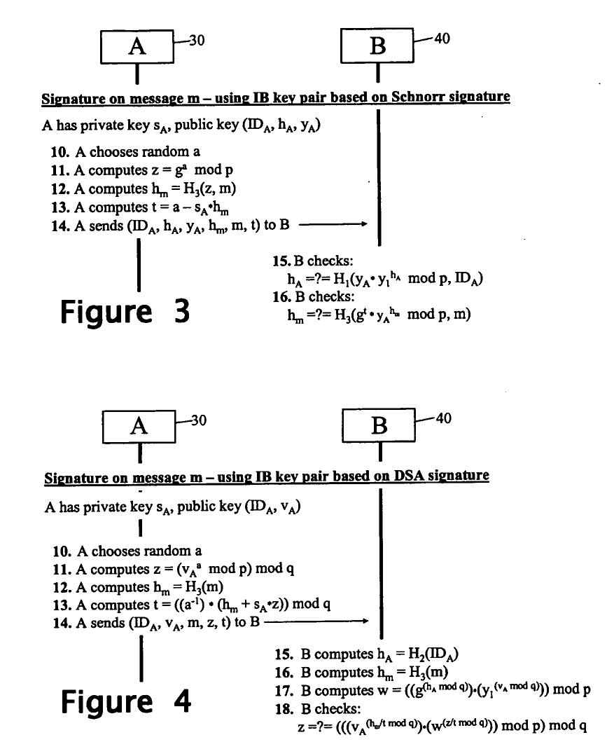

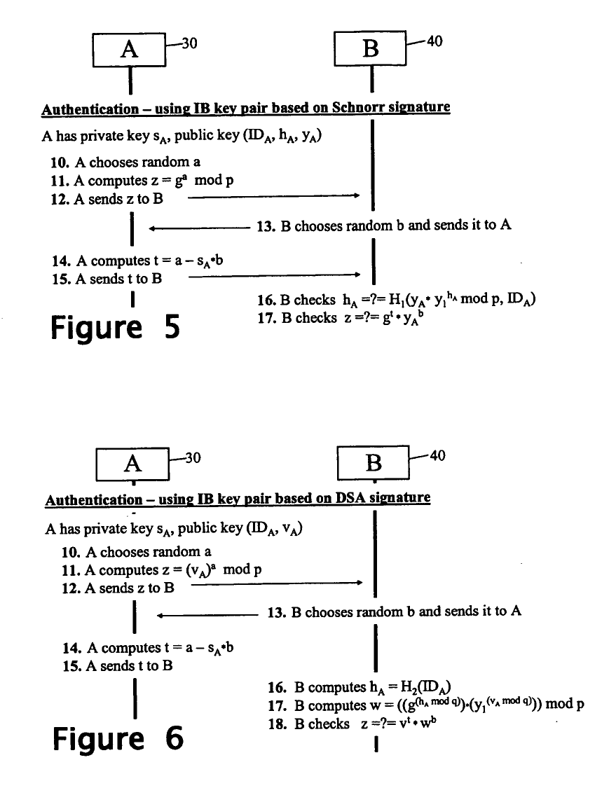

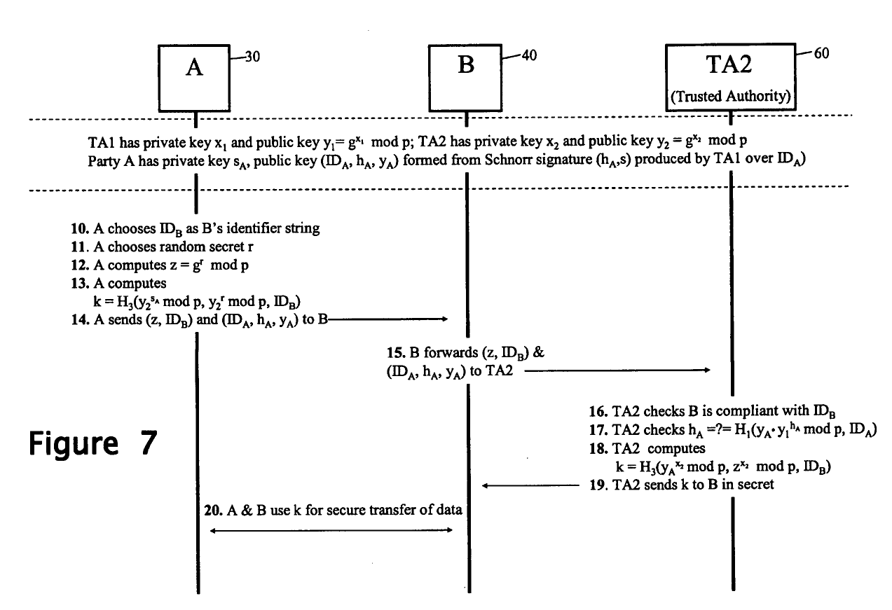

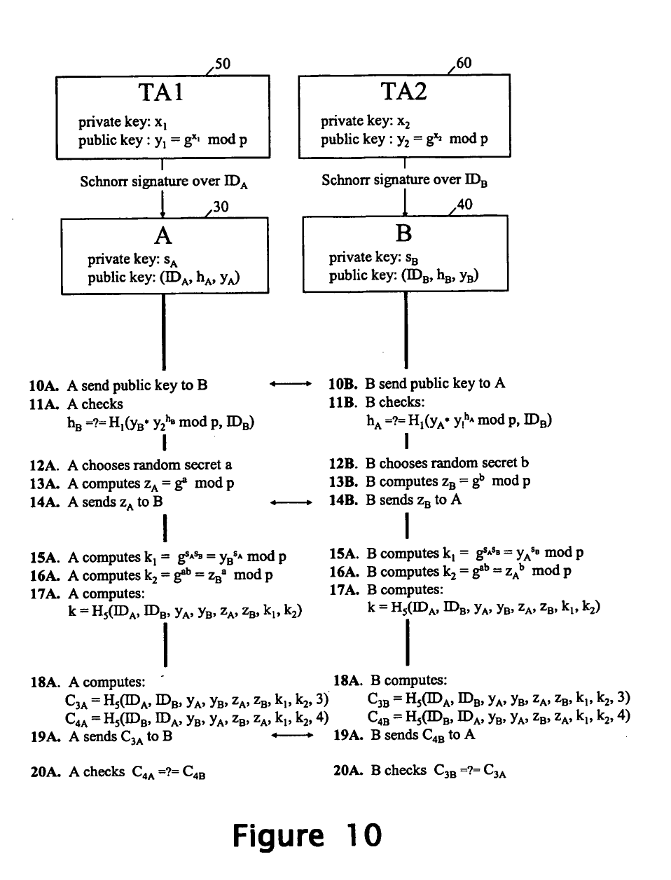

FIGS. 3 to 10 illustrate example usages of public/private key pairs generated according to FIG. 1 and FIG. 2. More particularly, FIGS. 3 and 4 concern signature services provided using these key pairs, FIGS. 5 and 6 concern authentication services provided using these key pairs, FIGS. 7 to 9 concern authenticated key distribution services provided using these key pairs, and FIG. 10 concerns a two-party authenticated key-sharing protocol.

It is important to note that generally in the following, symbols used in respect of a particular Figure and its related description are only consistent and non-conflicting within that context; thus, the same symbol may be re-used, with a different meaning, in connection with a different Figure. However, symbols used in FIG. 1 in relation to the generation of a key pair from a Schnorr signature are re-used, without conflict, in the usage examples based on key pairs so formed; similarly, symbols used in FIG. 2 in relation to the generation of a key pair from a DSA signature are re-used, without conflict, in the usage examples based on key pairs sp formed. Thus, although the symbols h_{A} and s_{A} have different meanings in FIGS. 1 and 2, the h_{A} and s_{A} of FIG. 1 are re-used consistently in the related usage examples of FIGS. 3, 5, 7 and 9; similarly, the h_{A} and s_{A} of FIG. 2 are re-used consistently in the related usage examples of FIGS. 4, 6, and 8.

Generation of IB Key Pair from Schnorr Signature—FIG. 1

In this embodiment, after the trusted authority TA1 has authenticated the association between party A and an identifier IDA provided by party A, TA1 signs the identity IDA using a Schnorr signature and provides the signature components (h_{A}, s_{A}) to party A. Party A then derives a public/private key pair from these signature components.

The operations carried out in this embodiment by party A and TA1 are described below with reference to FIG. 1, these operations being numbered 1 to 9.

TA1 Initial Set Up Phase

1. System public parameters p, q, g are established by TA1 (or another entity); typically:
q is a random prime (for example of 160 bits)
p is a random prime (for example of 1024) such that q|p-1
g is a random integer such that g^{q}=1 mod p

2. TA1 chooses random secret x₁ (TA1's private key) such that 1<x₁<q

3. TA1 computes y₁=g^{x}^{₁} mod p (TA1's public key)

4. TA1 publishes y₁ and keeps x₁ secret

TA1 signs Party A Identifier using Schnorr Signature

5. A chooses identifier ID_{A} and sends it to TA1

6. TA1 checks A is compliant/validly associated with ID_{A}

7. TA1 computes Schnorr signature over ID_{A} by:
choosing secret u at random in the range 0<u<q−1
computing:
   h_{A}=H₁(g^{u} mod p, ID_{A})
where H₁ is a one-way hash function applied to a deterministic combination of (g^{u} mod p) and ID_{A}—this combination is, for example a string concatenation.
computing:
   s_{A}=u−x₁*h_{A} mod q

8. TA1 sends signature (h_{A}, s_{A}) to A in secret

Key Pair Generation by Party A

9. Party A keeps s_{A} as her ID private key and computes:
y_{A}=g^{s}^{_{A}} mod p
to complete her ID public key (ID_{A}, h_{A}, y_{A})
Generation of IB Key Pair from DSA Signature—FIG. 2

In this embodiment, after the trusted authority TA1 has authenticated the association between party A and an identifier ID_{A} provided by party A, TA1 signs the identity IDA using a DSA signature and provides the signature components (f_{A}, s_{A}) to party A. Party A then derives a public/private key pair from these signature components.

The operations carried out in this embodiment by party A and TA1 are described below with reference to FIG. 2, these operations being numbered 1 to 9.

TA1 Initial Set Up Phase

1. System public parameters p, q, g are established by TA1 (or another entity); typically:
q is a random prime (for example of 160 bits)
p is a random prime (for example of 1024) such that q|p−1
g is a random integer such that g^{q}=1 mod p

2. TA1 chooses random secret x₁ (TA1's private key) such that 1<x₁<q

3. TA1 computes y₁=g^{x}^{₁} mod p (TA1's public key)

4. TA1 publishes y₁ and keeps x₁ secret

TA1 signs Party A Identifier using DSA Signature

5. A chooses identifier ID_{A} and sends it to TA1

6. TA1 checks A is compliant/validly associated with ID_{A}

7. TA1 computes DSA signature over ID_{A} by:
choosing secret u at random in the range 0<u<q−1
computing:
   h_{A}=H₂(ID_{A})
where H₂ is a one-way hash function
computing:
   f_{A}=(g^{u} mod p) mod q
   s_{A}=(u⁻¹)*(h_{A}+x₁*f_{A})) mod q

8. TA1 sends signature (f_{A}, s_{A}) to A in secret

Key Pair Generation by Party A

9. Party A keeps s_{A} as her ID private key and computes:
v_{A}=((g^{(h}^{_{A}}^{/s}^{_{A}} ^{mod q)}*(y₁^{(f}^{_{A}}^{/s}^{_{A}} ^{mod q)})) mod p
to complete her ID public key (ID_{A}, v_{A})

As a variant of the foregoing, in operation 7 TA1 can, after computing h_{A}, complete the computation of the DSA signature as follows:
v_{A}=g mod p
s_{A}=((u⁻¹)*(h_{A}+xᵢ*(v_{A} mod q))) mod q
In this case, in operation 8 TA1 sends A the signature (v_{A}, s_{A}) instead of (f_{A}, s_{A}) thereby obviating the need for A to compute the value v_{A} from (f_{A}, s_{A}, h_{A}) in operation 9. The advantage of this variant is the reduction in A's computation; however, the amount of data communicated between A and TA1 is increased because the size of v_{A} is |p| whereas the size of f_{A} was |q|.

### Example Usages

### Signing/Verification—FIGS. 3 and 4

A signing/verification example usage for the public/private key pairs generated by the methods of FIGS. 1 and 2 will now be described with reference to FIGS. 3 and 4. In these examples, the party A that possesses the public/private key pair uses the private key to generate a signature over a message m; subsequently, another party B uses the public key of the key pair to verify the signature in respect of the message m.

Example using key pair based on a Schnorr signature—the operations carried out by the message-signing party A and the signature-verifying party B are described below with reference to FIG. 3, these operations being numbered 10 to 16 and building on the key-pair generation operations 1 to 9 of FIG. 1. Party A has private key s_{A} and public key (ID_{A}, h_{A}, y_{A}).

Party A generates Schnorr Signature Over Message m

10. Party A chooses secret a at random in the range 0<a<q

11. Party A computes z=g^{a} mod p

12. Party A computes hₘ=H₃(z, m) where H₃ is a one-way hash function applied to a deterministic combination of z and m—this combination is, for example a string concatenation.

13. Party A computes t=a−s_{A}*hₘ

14. Party A sends (ID_{A}, h_{A}, y_{A}, hₘ, m, t) to party B

Party B verifies Signature Over Message m

15. Party B checks:
h_{A}=?=H₁(y_{A}*y₁^{h}^{_{A}} mod p, ID_{A})

16. Party B checks:
hₘ=?=H₃(g¹*y_{A}^{h}^{ₘ} mod p, m)
If both checks are passed, the signature is verified.

Example using key pair based on DSA signature—the operations carried out by the message-signing party A and the signature-verifying party B are described below with reference to FIG. 4, these operations being numbered 10 to 16 and building on the key-pair generation operations 1 to 9 of FIG. 2. Party A has private key s_{A} and public key (ID_{A}, v_{A}).

Party A Generates DSA Signature Over Message m

10. Party A chooses secret a at random in the range 0<a<q

11. Party A computes z=(v_{A}^{a} mod p) mod q

12. Party A computes hₘ=H₃(m) where H₃ is a one-way hash function

13. Party A computes t=((a⁻¹)*(hₘ+s_{A}*z)) mod q

14. Party A sends (ID_{A}, v_{A}, m, z, t) to party B

Party B Verifies Signature Over Message m

15. Party B computes h_{A}=H₂(ID_{A})

16. Party B computes hₘ=H₃(m)

17. Party B computes w=((g^{(h}^{_{A}} ^{mod q)})*(y₁^{(v}^{_{A}} ^{mod q)})) mod p

18. Party B checks:
z=?=(((v_{A}^{(h}^{ₘ}^{/t mod q)})*(w^{(z/t mod q)})) mod p) mod q

If this check is passed, the signature is verified.

### Example Usages

### Authentication—FIGS. 5 and 6

An authentication example usage for the public/private key pairs generated by the methods of FIGS. 1 and 2 will now be described with reference to FIGS. 5 and 6. When party A wants to authenticate herself to another party B, party A first sends B her public key.

Subsequently, party A is challenged by party B and must use its private key to provide a correct response to the challenge. The purpose of the authentication process is enable party A to convince party B that A's public key is associated with TA1's public key y₁ in a way requiring cooperation of TA1—thus, if party B trusts TA1, party B can trust that the identifier ID_{A} is correctly associated with party A. Note that there is no explicit key certificate or certificate verification process.

Example using key pair based on a Schnorr signature—the operations carried out by the parties A and B are described below with reference to FIG. 5, these operations being numbered 10 to 17 and building on the key-pair generation operations 1 to 9 of FIG. 1. Party A has private key s_{A} and public key (ID_{A}, h_{A}, y_{A}).

Challenge—Response Phase

10. Party A chooses secret a at random in the range 0<a<q

11. Party A computes z=g^{a} mod p

12. Party A sends z to party B

13. Party B chooses secret b at random in the range 0<b<2⁴⁰ and sends it to A

14. Party A computes t=a−s_{A}*b

15. Party A sends t to party B

16. Party B checks h_{A}=?=H₁(y_{A}*y₁^{h}^{_{A}} mod p, ID_{A})

17. Party B checks z=?=g^{t}*y_{A}^{b}

If both checks are passed, party A has been successfully authenticated.

Check operation 16 can be carried out as soon as party B receives party A's public key with the remaining operations not being effected if the check fails.

Example using key pair based on DSA signature—the operations carried out by the parties A and B are described below with reference to FIG. 6, these operations being numbered 10 to 18 and building on the key-pair generation operations 1 to 9 of FIG. 2. Party A has private key s_{A} and public key (ID_{A}, V_{A}).

Challenge—Response Phase

10. Party A chooses random a

11. Party A computes z=v_{A}^{a} mod p

12. Party A sends z to party B

13. Party B chooses secret b at random in the range 0<b<2⁴⁰ and sends it to A

14. Party A computes t=a−s_{A}*b

15. Party A sends t to party B

16. B computes h_{A}=H₂(ID_{A})

17. B computes w=((g^{(h}^{_{A}} ^{mod q)})*(y^{(v}^{_{A}} ^{mod q)}) mod p

18. B checks z=?=v_{A}^{t}*w^{b}

If this check is passed, party A has been successfully authenticated.

### Example Usages

### Key Distribution—FIGS. 7 to 9

A key distribution example usage for the public/private key pairs generated by the methods of FIGS. 1 and 2 will now be described with reference to FIGS. 7 to 9. In these examples, parties A and B both end up with the same inter-party symmetric key k, this key being generated by party A for itself and by TA2 for party B. In addition, party B is authenticated to party A by TA2 (which party A has chosen to trust with verifying that party B is compliant with an identifier ID_{B} specified by party A). Furthermore, the overall process is such that the only party (apart from TA2) that can compute the inter-party symmetric key k is the party identified by ID_{A} whereby party B is assured (to the extent it trusts TA1) that if it can successfully communicate using the key k, then this must be with party A or a party authorised by party A.

Example using key pair based on a Schnorr signature and TAs with same public system parameters. In this example usage, both trusted authorities TA1 and TA2 use the same system parameters p, q and g. As well as TA1 having derived a private key x₁ and public key y₁ as described above with reference to operations 2 to 4 of FIG. 1, TA2 will have carried out equivalent operations to derive its own private key x₂ and public key y₂(=g^{x}^{₂} mod p).

The operations carried out in this example key-distribution method by A, B, TA1 and TA2 are described below with reference to FIG. 7, these operations being numbered 10 to 20 and building on the key-pair generation operations 1 to 9 of FIG. 1. Party A has private key s_{A} and public key (ID_{A}, h_{A}, y_{A}).

When Party A Wants to Share an Inter-Party Symmetric Key k With Party B

10. Party A chooses ID_{B} as B's identifier string

11. Party A chooses secret r at random in range 0<r<q

12. Party A computes:
z=g^{r} mod p

13. Party A computes:
k=H₃(y₂^{s}^{_{A}} mod p, y₂^{r} mod p, ID_{B})
where H₃ is a one-way hash function applied to a deterministic combination of its terms—this combination is, for example a string concatenation.
   and stores k as the inter-party symmetric key

14. Party A sends (z, ID_{B}) and (ID_{A}, h_{A}, y_{A}) to party B

15. Party B forwards (z, ID_{B}) and (ID_{A}, h_{A}, y_{A}) to TA2

16. TA2 checks party B is compliant with ID_{B}—if this check fails, processing terminates.

17. TA2 checks:
h_{A}=?=H₁(y_{A}*y₁^{h}^{_{A}} mod p, ID_{A})
As explained more fully below, if this check is passed, TA2 knows that only a party verified by TA1 as entitled to be associated with ID_{A} (as received by TA2) will be able to generate a correct value for the inter-party key k, this being a value which is the same as that which TA2 will compute in operation 18 below. If the check fails, processing terminates.

18. TA2 computes:
k=H₃(y_{A}^{x}^{₂} mod p, z^{x}^{₂} mod p, ID_{B})

19. TA2 sends k, as the inter-party symmetric key, to party B in secret

20. Parties A & B use the inter-party symmetric key k for the secure transfer of data

It will be appreciated that H₁ and H₃ can be the same one-way hash function.

In the foregoing process the signing of ID_{A} by TA1 using a Schnorr signature and the retention of the signature component s_{A} by A whilst passing on the derivative element g^{s}^{_{A}} mod p, enables TA2 to assume that the party associated with the identity ID_{A} holds the component element s_{A}. Because the inter-party key k is of such a form that only TA2 or the party possessing the secret s_{A} can construct the key correctly, TA2 knows that the key k it forms will only be useful for communicating with a party verified by TA1 as identified by ID_{A}.

It should be noted that (h_{A}, s_{A}) is a valid Schnorr signature on ID_{A}, but (h_{A}, y_{A}) is not because anyone can falsify it without knowing x₁ by randomly choosing u, and computing:
h_{A}=H₂(g^{u} mod p∥ID_{A}) and
y_{A}=g^{u}/y₁^{h}^{_{A}} mod p.
However, (h_{A}, y_{A}) becomes a valid Schnorr signature on ID_{A} for the case where the discrete logarithm s_{A} of y_{A} based on g modulo p is known to the party identified by ID_{A} since it is an acceptable assumption that solving the discrete logarithm problem in a finite field is computationally infeasible. For the present embodiment, the computation of g^{sx}^{₂} mod p required for computing the key k needs knowledge of either s_{A} or x₂ (for the same reason that solving the discrete logarithm problem in a finite field is computationally infeasible). Because x₂ is known only to TA2, TA2 believes that g^{sx}^{₂} mod p can only be computed by itself or someone knowing s. Therefore if the check operation 17 is passed, TA2 knows that either (h_{A}, y_{A}) is a valid Schnorr signature and the party A identified by ID_{A} will be able to generate the same value of the key k as TA2, or that the signature is invalid and the identified party will be unable to generate a value of the key matching that generated by TA2.

Regarding the construction of the key k, in the foregoing process A and TA2 effectively perform two Diffie-Hellman (DH) key exchanges. In the first of these exchanges, A's secret is r and TA2's secret is x₂; the result of this exchange is that A and TA2 share a DH key g^{rx}^{₂} mod p (this key having been formed by A as: y₂^{r} mod p, and by TA2 as: z^{x}^{₂} mod p). In the second DH key exchange, A's secret is s_{A} and TA2's secret is x₂; the result of this exchange is that A and TA2 share a DH key g^{s}^{_{A}}^{x}^{₂} mod p (this key having been formed by A as: y₂^{s}^{_{A}} mod p, and by TA2 as: y_{A}^{x}^{₂} mod p). Both A and TA2 then form the inter-party symmetric key k as a hashed combination of the two DH keys and the identifier string ID_{B}. Placing the DH key g^{s}^{_{A}}^{x}^{₂} mod p inside the hash both guarantees to A that TA2 must be involved in generating the key for B, and as already discussed, guarantees for TA2 that only the party identified by ID_{A} can generate the key (apart from TA2); placing ID_{B} inside the hash ensures that it is impossible for B to adapt the key to a different identity ID_{B′}. Placing the DH key g^{rx}^{₂} mod p in the hash, as well as being a repeat guarantee to A of the involvement of TA2, also serves to ensure freshness (assuming that r is newly generated at random each time A wants to communicate with B).

The DH key g^{rx}^{₂} mod p can be omitted from the hashed combination of terms used to derive k but in this case freshness of the key for each use with party B will (if required) need to be provided for in some other manner such as by the inclusion of a nonce in ID_{B}. Omitting the term g^{rx}^{₂} mod p also means that TA1 can construct the key k (assuming it knows ID_{B}).

Example using key pair based on a DSA signature and TAs with same public system parameters. In this example usage, both trusted authorities TA1 and TA2 again use the same system parameters p, q and g. Thus, as well as TA1 having derived a private key x₁ and public key y₁ as described above with reference to operations 2 to 4 of FIG. 2, TA2 will have carried out equivalent operations to derive its own private key x₂ and public key y₂ (=g^{x}^{₂} mod p).

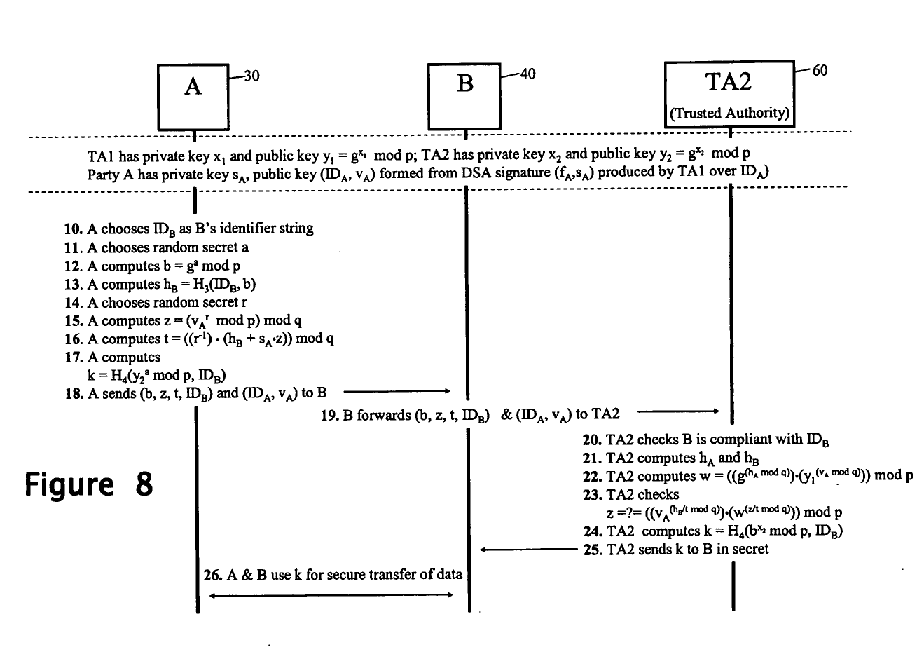

The operations carried out in this example key-distribution method by A, B, TA1 and TA2 are described below with reference to FIG. 8, these operations being numbered 10 to 26 and building on the key-pair generation operations 1 to 9 of FIG. 2. Party A has private key s_{A} and public key (ID_{A}, v_{A}).

When Party A Wants to Share an Inter-Party Symmetric Key k With Party B

10. Party A chooses ID_{B} as party B's identifier string

11. Party A chooses integer a at random such that 1<a<q

12. Party A computes b=g^{a} mod p

13. Party A computes h_{B}=H₃(ID_{B}, b)
where H₃ is a one-way hash function applied to a deterministic combination of its terms—this combination is, for example a string concatenation.

14. Party A chooses random secret r such that 1<b<q

15. Party A computes:
z=(v_{A}^{r} mod p) mod q

16. Party A computes:
t=((r⁻¹)*(h_{B}+s_{A}*z)) mod q

17. Party A computes:
k=H₄(y₂^{a} mod p, ID_{B})
where H₄ is a one-way hash function applied to a deterministic combination of its terms—this combination is, for example a string concatenation.
   and stores k as the inter-party symmetric key

18. Party A sends (b, z, t, ID_{B}) and (ID_{A}, v_{A}) to party B

19. Party B forwards (b, z, t, ID_{B}) & (ID_{A}, v_{A}) to TA2

20. TA2 checks B is compliant with ID_{B}—if this check fails, processing terminates

21. TA2 computes:
h_{A}=H₂(ID_{A})
h_{B}=H₃(ID_{B}, b)

22. TA2 computes:
w=((g^{(h}^{_{A}}^{mod q)})*(y₁^{(v}^{_{A}} ^{mod q)})) mod p

23. TA2 checks
z=?=((v_{A}^{(h}^{_{B}}^{/t mod q)})*(w^{(z/t mod q)})) mod p
If this check is passed, TA2 knows that only a party verified by TA1 as entitled to be associated with ID_{A} (as received by TA2) will be able to generate a correct value for the inter-party key k, this being a value which is the same as that which TA2 will compute in operation 24 below. If the check fails, processing terminates.

24. TA2 computes:
k=H₄(b^{x}^{₂} mod p, ID_{B})

25. TA2 sends k, as the inter-party symmetric key, to party B in secret

26. Parties A & B use the inter-party symmetric key k for the secure transfer of data

Example using key pair based on a Schnorr signature and TAs with different public system parameters. In this example usage, the trusted authority TA1 has public system parameters p₁, q₁ and g₁, and the trusted authority TA2 has public system parameters p₂, q₂ and g₂. TA1 has derived a private key x₁ and public key y₁(=g₁^{x}^{₁} mod p₁) from its public parameters in a manner corresponding to operations 2 to 4 of FIG. 1, and TA2 has carried out equivalent operations to derive its own private key x₂ and public key y₂(=g₂^{x}^{₂} mod p₂).

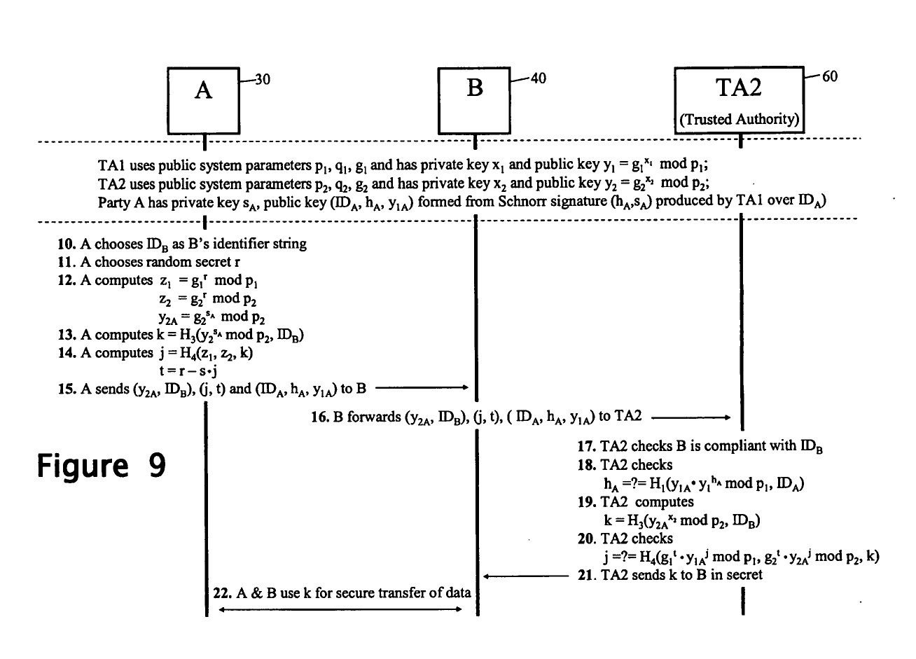

The operations carried out in this example key-distribution method by A, B, TA1 and TA2 are described below with reference to FIG. 9, these operations being numbered 10 to 22 and building on the key-pair generation operations 1 to 9 of FIG. 1. Party A has private key s_{A} and public key (ID_{A}, h_{A}, y_{1A}) based on the public system parameters of TA1.

When Party A Wants to Share an Inter-Party Symmetric Key k With Party B

10. A chooses ID_{B} as B's identifier string

11. A chooses secret r at random in the range: 0<r<min (q₁, q₂)

12. A computes:
z₁=g₁^{r} mod p₁
z₂=g₂^{r} mod p₂
y_{2A}=g₂^{s}^{_{A}} mod p₂

13. A computes:
k=H₃(y₂^{s}^{_{A}} mod p₂, ID_{B})
where H₃ is a one-way hash function where H₃ is a one-way hash function applied to a deterministic combination of its terms—this combination is, for example a string concatenation.
   and stores k as the inter-party symmetric key

14. A computes:
j=H₄(z₁, z₂, k)
where H₄ is a one-way hash function where H₃ is a one-way hash function applied to a deterministic combination of its terms—this combination is, for example a string concatenation.
   t=r−s_{A}*j mod max(q₁, q₂) or without mod

15. A sends (j, t, y_{2A}, ID_{B}) and (ID_{A}, h_{A}, Y_{1A}) to B

16. B forwards (y_{2A}, ID_{B}) (j, t) and (ID_{A}, h_{A}, Y_{1A}) to TA2

17. TA2 checks B is compliant with ID_{B}—if this check fails, processing terminates.

18. TA2 checks:
h=?=H₂(Y_{1A}*y₁^{h}^{_{A}} mod p₁, ID_{A})
If this check is passed, TA2 knows, subject to the check of operation 20, that only a party verified by TA1 as entitled to be associated with ID_{A} (as received by TA2) can compute a correct value for the inter-party key k, this being a value which is the same as that which TA2 will compute in operation 19 below. If the check fails, processing terminates.

19. TA2 computes:
k=H₃(Y_{2A}^{x}^{₂} mod P₂, ID_{B})

20. TA2 checks:
j=?=H₄(g₁^{t}*y_{1A}^{j} mod p₁, g₂^{t}*Y_{2A}^{j} mod p₂, k)

21. TA2 sends k, the inter-party symmetric key, to B in secret

22. A and B use the inter-party symmetric key k for secure transfer of data

It will be appreciated that H₁, H₃ and H₄ can be the same one-way hash function.

As for the FIG. 7 example usage, the check operation 18 tells TA2 that (h_{A}, Y_{1A}) is a valid signature on ID_{A} in the case where the party identified by ID_{A} knows the discrete logarithm s_{A} of y_{1A} on the base g₁ modulo p₁. However, because computation of k by TA2 necessarily involves y_{2A} (based on g₂) rather than the Y_{1A} value (based on g₁) used in the signature verification process, TA2 can no longer assume that the resultant value of k will only be useful where the signature values have not been falsified. For avoiding this ambiguity, A demonstrates to TA2 that the discrete logarithm of Y_{1A} on the base g₁ modulo p₁ is equal to the discrete logarithm of y_{2A} on the base g₂ modulo p₂. To do this, A makes use of a double Schnorr signature (j, t) on the value k under “public key” Y_{1A} and y_{2A}, which is computed as follows:
z₁=g₁^{r} mod p₁
z₂=g₂^{r} mod p₂
j=H₄(z₁, z₂, k)
t=r−s_{A}*j mod max(q₁, q₂) or without mod
This signature can be verified by checking if j=H₄(g₁^{t}*y_{1A}^{j} mod p₁, g₂^{t}*y_{2A}^{j} mod p₂, k) holds. After this check succeeds, TA2 is convinced that (h_{A}, y_{1A}) is a valid Schnorr signature on ID_{A} signed by TA 1.

Again as for the FIG. 7 example usage, creation of the inter-party symmetric key k requires computation of g₂^{s}^{_{A}}^{x}^{₂} mod p₂, which calls for knowledge of either s_{A} or x₂ since solving the discrete logarithm problem in a finite field is computationally infeasible. Because x₂ is known only to TA2, TA2 believes that g₂^{s}^{_{A}}^{x}^{₂} mod p₂ can only be computed by itself or someone knowing s, and that the value s_{A} is also the discrete logarithm of y_{1A} on the base g₁ modulo p₁. TA2 is therefore convinced that it shares the value k with the right entity A.

Regarding the construction of the key k, in the foregoing process A and TA2 effectively perform a DH key exchange involving A's secret s_{A} and TA2's secret x₂; the result of this exchange is that A and TA2 share a DH key g₂^{s}^{_{A}}^{X}^{₂} mod p₂ (this key having been formed by A as: y₂^{s}^{_{A}} mod p₂, and by TA2 as: y_{2A}^{x}^{₂} mod p₂). Both A and TA2 then form the inter-party symmetric key k as a hashed combination of the DH key and the identifier string ID_{B}. Placing the DH key g₂^{s}^{_{A}}^{x}^{₂} mod p₂ inside the hash both guarantees to A that TA2 must be involved in generating the key for B, and as already discussed, guarantees for TA2 that only the party identified by ID_{A} can generate the key (apart from TA2); placing ID_{B} inside the hash ensures that it is impossible for B to adapt the key to a different identity ID_{B′}.

If freshness of the key k is required for each use with the party B then this can be achieved by the inclusion of a nonce in ID_{B}. Alternatively, an approach similar to that used in the FIG. 2 embodiment can be used, namely the DH key g₂^{rx}^{₂} mod p₂ can be included in the hashed combination when forming k, this key being formed by A as: y₂^{r} mod p₂, and by TA2 as: z₂^{x}^{₂} mod p₂; thus, A would form k as:
k=H₁(y₂^{x}^{₂} mod p₂, y₂^{r} mod p₂, ID_{B})
Special cases of the FIG. 9 arrangement are when:
p₁=p₂ and q₁=q₂ but g₁≈g₂; and
p₁=p₂ and q₁=q₂ and g₁=g₂.
   In the latter case, it is preferable to use the FIG. 7 arrangement.

With regard to the computational load on party A in the FIG. 9 example usage, whilst at first sight this might appear significant, this will generally not be the case because the results of most of the computations can be re-used multiple times. Thus:
whilst y₁ and ID_{A} remain unchanged, the ID public key (ID_{A}, h_{A}, y_{1A}) need only be sent once to TA2;
whilst y₁, g₂ and ID_{A} remain unchanged, the value y_{2A} need not be recomputed;
whilst y₁, y₂ and ID_{A} remain unchanged, (y₂^{s} mod p) need not be recomputed;
whilst ID_{A}, ID_{B, y1} and y₂ remain unchanged, k need not be recomputed;
z₁ and Z₂ need only be computed once.
   There will therefore be many occasions when computation for party A will be very light and not involve any exponentiation. With regard to the computational load for TA2, this will depend on whether it has already accepted y_{1A} and y_{2A} or not.

Furthermore, in practical implementations it is not necessary to make q₁ and q₂ publicly available though in this case, x, r and u are preferably one bit smaller than q₁ and q₂.

### Example Usages

### Two-Party Authenticated Key Agreement—FIG. 10

A two-party authenticated key agreement example usage for the public/private key pairs generated by the methods of FIGS. 1 and 2 will now be described. In this example usage, the parties A and B both start with respective ID-based public/private key pairs (generated in cooperation with TA1 and TA2 respectively), and perform the same series of operations in order to generate the same inter-party symmetric key k. Due to the nature of the overall process, each party A/B knows that the only other entity that can generate the inter-party symmetric key k is the party identified by ID_{B}/ID_{A} whereby the party A/B is assured (to the extent it trusts TA2/TA1) that if it can successfully communicate using the key k, then this must be with the party B/A (or a party authorised by the party B/A).

In the specific example described below with reference to FIG. 10, both trusted authorities TA1 and TA2 use the same system parameters p, q and g. As well as TA1 having derived a private key x₁ and public key y₁ as described above with reference to operations 2 to 4 of FIG. 1, TA2 will have carried out equivalent operations to derive its own private key x₂ and public key y₂(=g^{x}^{₂} mod p).

Furthermore, party A with ID_{A} has a private key s_{A} and public key (ID_{A}, h_{A}, y_{A}) derived from a Schnorr-type signature of ID_{A} by TA1 in accordance with the key-pair generation operations 1 to 9 of FIG. 1. Similarly, party B with ID_{B} has a private key s_{B} and public key (ID_{B}, h_{B}, y_{B}) derived from a Schnorr-type signature of ID_{B} by TA2 in accordance with the key-pair generation operations 1 to 9 of FIG. 1

The operations carried out in this example key-sharing method by the parties A and B are numbered 10 to 20. As already indicated, the operations performed by the parties A and B are the same; for convenience, to distinguish between the same operation carried out by party A and party B, the operations carried out by party A are numbered 10A to 20A whereas the operations carried out by party B are numbered 10B to 20B.

When Party A wants to agree an inter-party symmetric key k with party B:

Phase I—Public key exchange and verification

10A. A sends its public key (ID_{A}, h_{A}, y_{A}) to B

10B. B sends its public key (ID_{B}, h_{B}, Y_{B}) to A

11A. A checks: h_{B}=?=H₁(Y_{B}*y₂^{h}^{_{B}} mod p, ID_{B})

11B. B checks: h_{A}=?=H₁(y_{A}*y₁^{h}^{_{A}} mod p, ID_{A})
The checks carried out in operations 11A and 11B do not give A or B any assurance regarding authentication of the received public keys; however, if a check fail, the party carrying out the check knows that the received public key is invalid and therefore terminates processing.
   Phase II—Unauthenticated DH Key Material Exchange

12A. A chooses secret a at random in the range 1<a<q−1

12B. B chooses secret b at random in the range 1<b<q−1

13A. A computes Z_{A}=g^{a} mod p

13B. B computes Z_{B}=g^{b} mod p

14A. A sends Z_{A} to B

14B. B sends Z_{B} to A

15A. A computes k₁=g^{s}^{_{A}}^{s}^{_{B}}=Y_{B}^{s}^{_{A}} mod p

15B. B computes k₁=g^{s}^{_{A}}^{s}^{_{B}}=Y_{A}^{s}^{_{B}} mod p

Phases I and II can be Carried Out in any Order Relative to Each Other

Phase III—Symmetric Key Generation

16A. A computes k₂=g^{ab}=z_{B}^{a} mod p

16B. B computes k₂=g^{ab}=z_{A}^{b} mod p

17A. A computes inter-party symmetric key k=H₅(ID_{A}, ID_{B}, y_{A}, y_{B}, z_{A}, z_{B}, k₁, k₂)
where H₅ is a one-way hash function applied to a deterministic combination of its terms—this combination is, for example a string concatenation.

17B. B computes inter-party symmetric key k=H₅(ID_{A}, ID_{B}, y_{A}, y_{B}, z_{A}, z_{B}, k₁, k₂)

Phase IV (Optional)—Key Confirmation Exchange (Example)

18A. A computes:
C_{3A}=H₅(ID_{A}, ID_{B}, y_{A}, y_{B}, z_{A}, z_{B}, k₁, k₂, 3)
C_{4A}=H₅(ID_{B}, ID_{A}, y_{B}, y_{A}, z_{B}, z_{A}, k₁, k₂, 4)

18B. B computes:
C_{3B}=H₅(ID_{A}, ID_{B}, y_{A}, y_{B}, z_{A}, z_{B}, k₁, k₂, 3)
C_{4B}=H₅(ID_{B}, ID_{A}, y_{B}, y_{A}, z_{B}, z_{A}, k₁, k₂, 4)

19A. A sends C_{3A} to B

19B. B sends C_{4B} to A

20A. A checks C_{4A}=?=C_{4B}

20B. B checks C_{3B}=?=C_{3A}
If either of the checks carried out in operations 20A and 20B fails, the key k is rejected.

Notwithstanding that the above protocol starts with an unauthenticated public key exchange and an unauthenticated DH key material exchange, the end result is an authenticated shared key.

It will be appreciated that the hash functions used in operations 18A and 18B can be different from that used in operations 17A and 17B; indeed, the hash function used to generate C_{3A} and C₃B can differ from the hash function used to generate C_{4A} and C_{4B}.

It will also be appreciated that the two parties A and B can use the same trusted authority (that is, TA1 and TA2 can be the same trusted authority).

Furthermore, the inter-party key k can be generated using fewer elements than specified in operations 17A and 17B above; thus, the elements ID_{A}, ID_{B}, y_{A}, and y_{B} can be omitted.

Although the presence of z_{A} and z_{B} are essential for a theoretical security proof since otherwise someone can break a matching conversation and then get a valid session key from an oracle, since such an attack has no practical benefit, the elements ZA and ZB could also be omitted though this is not preferred.

Generic Variants

It will be appreciated that many variants are possible to the above described embodiments and example usages of the invention.

For example, with respect to the key-distribution example usages of FIGS. 7 to 9, it will be appreciated that TA2 can generate the inter-party key k before, or in parallel with, carrying out its checks regarding compliance by B with the identifier string. Similarly, TA2 can generate the inter-party key k before, or in parallel with, its check regarding the identity of party A. In addition, TA2 can be arranged to pass the key k to party B even if the checks regarding party A are failed (party B preferably being informed of this failure). The parties A and B can use inter-party key k directly for encryption/decryption key or they can combine the key with other elements known to both parties before employing the key. All transmissions are preferably integrity protected in any suitable manner. One useful application of the above-described identifier-based key distribution example usages is in secure email applications.

With regard to the identifier string ID_{A}, this will generally comprise specific identity information regarding the party A and/or an indication of one or more attributes possessed by party A. The string ID_{A} can also include one or more indicators of actions to be carried out by TA2. The string ID_{A} can be chosen by trusted authority TA1 rather than being supplied by the party A (in this case, the trusted authority TA1 does not need to check that the party A is entitled to the identifier). Where the trusted authority TA1 does check the entitlement of party A to the identifier ID_{A}, this check can be deferred until after the trusted authority has computed its signature provided this is done before the signature is sent to party A.

With respect to the key-distribution example usages in which party A chooses an identifier string ID_{B} for party B, this string may be any string though in many cases restrictions will be placed on the string—for example, the string ID_{B} may be required to comply with a particular XML schema. The string ID_{B} will frequently comprise a condition identifying a specific person or entity for party B; in this case, the trusted authority TA2 carries out an authentication process with the party B to check that B meets the identity condition. Rather than identifying party B as a particular individual or entity, the identifier string ID_{B} may comprise one or more conditions specifying one or more attributes that a party must possess to receive the key k; for example, a condition may specify that a party must have a certain credit rating. Again, it is the responsibility of the trusted authority TA2 to check out this condition(s) before providing the key k to the party requesting it. The string ID_{B} may additionally or alternatively comprise one or more conditions unrelated to an attribute of the intended key recipient; for example, a condition may be included that the key k is not to be provided by TA2 before a particular date or time. Indeed, the string ID_{B} can be used to convey to the trusted authority TA2 information concerning any actions to be taken by the trusted authority when it receives the key request. The information in the string ID_{B} may thus relate to actions to be taken by the trusted authority that do not directly affect key provision—for example, the trusted authority TA2 may be required to send a message to party A at the time the TA2 provides the key to party B. However, as already indicated, the information in the string ID_{B} will generally specify one or more conditions to be checked by the trusted authority as being satisfied before the trusted authority provides the key to the requesting party. Whatever the conditions relate to, the string ID_{B} may directly set out the or each condition or may comprises one or more condition identifiers specifying corresponding predetermined condition known to the trusted authority TA2 (in the latter case, the trusted authority uses the or each condition identifier to look up the corresponding condition to be checked).

Preferably ID_{A} and/or ID_{B} contain nonces to ensure freshness.

1. A method of generating an identifier-based public/private key pair for a first party, comprising:
providing an identifier of the first party for use by a first trusted entity that has associated public values g, p, q, y and secret x where:
p and q are large primes satisfying q|p−1;
g is an integer such that g^{q}=1 mod p;
x is an integer such that 1<x<q; and
y=g^{x} mod p;
the first trusted entity using its secret x to compute a multi-component signature over the first-party identifier; and
converting the signature into the first-party identifier-based key pair, the private key of this key pair comprising a first component of the signature provided as a secret to the first party, and the public key being formed using at least another component of the signature and said identifier.

2. A method according to claim 1, wherein the first-party identifier is provided to the first trusted entity by the first party and the first trusted entity checks the entitlement of the first party to said identifier either before computing said signature or before providing the first component of the signature to the first party.

3. A method according to claim 1, wherein computing the multi-component signature involves an initial operation of generating a random secret that is then used in generating the signature itself.

4. A method according to claim 1, wherein the first trusted entity performs all computation required for deriving the first-party identifier-based key pair.

5. A method according to claim 1, wherein the first party performs computation to convert the signature to the first-party identifier-based key pair.

6. A method according to claim 1, wherein said signature is a Schnorr signature

7. A method according to claim 6, wherein the first trusted entity computes the Schnorr signature over the first party identifier ID_{A} by:
choosing secret u at random in the range 0<u<q−1;
computing:
h_{A}=H₁(g^{u} mod p, ID_{A})
where H₁ is a one-way hash function applied to a deterministic combination of (g^{u} mod p) and ID_{A};
computing:
s_{A}=u−x*h_{A} mod q
where h_{A} and s_{A} constitute the signature components;
the first party converting the signature to the identifier-based key pair by using the component s_{A} as the private key and computing:
y_{A}=g^{s}^{_{A}} mod p
to complete the identifier-based public key ID_{A}, h_{A}, y_{A}

8. A method according to claim 1, wherein said signature is a DSA signature.

9. A method according to claim 8, wherein the first trusted entity computes the DSA signature over the first party identifier ID_{A} by:
choosing secret u at random in the range 0<u<q−1
computing:
h_{A}=H₂(ID_{A})
where H₂ is a one-way hash function
computing:
f_{A}=(g^{u} mod p) mod q
s_{A}=(u⁻¹)*(h_{A}+x*f_{A})) mod q
where f_{A} and s_{A} constitute the signature components;
the first party converting the signature to the identifier-based key pair by using the component s_{A} as the private key and computing:
v_{A}=((g^{(h}^{_{A}}^{/s}^{_{A}} ^{mod q)})*(y^{(f}^{_{A}}^{/s}^{_{A}} ^{mod q)})) mod p
to complete the identifier-based public key ID_{A}, v_{A}.

10. A method according to claim 8, wherein the first trusted entity computes the DSA signature over the first party identifier ID_{A} by:
choosing secret u at random in the range 0<u<q−1
computing:
h_{A}=H₂(ID_{A})
where H₂ is a one-way hash function
computing:
v_{A}=g^{u} mod p
s_{A}=((u⁻¹)*(h_{A}+x*(v_{A} mod q))) mod q
where v_{A} and s_{A} constitute the signature components;
the first party converting the signature to the identifier-based key pair by using the component s_{A} as the private key, and the component v_{A} and identifier ID_{A} as the identifier-based public key.

11. A cryptographic key distribution method, comprising:
providing a first party with a first-party identifier-based public/private key pair generated in accordance with claim 1;
the first party choosing a second-party identifier comprising at least one condition;
a second trusted entity receiving the first-party identifier, the second-party identifier, and the public key of the first-party identifier-based key pair, and providing a second party with an inter-party symmetric key for use in secure data exchange between the first and second parties only if the second trusted entity is satisfied both that:
the second party meets said at least one condition in the second identifier; and
on the basis of the public key of the first-party identifier-based key pair, only a party verified by the first trusted entity as entitled to be associated with the first-party identifier as received by the second trusted entity, will be able to generate a correct value for the inter-party symmetric key;
the first party generating said inter-party symmetric key;
the second trusted entity and first party having a shared base key and each generating said inter-party symmetric key by applying a one-way hash function to a deterministic combination of at least the second-party identifier and said base key.

12. A method according to claim 11, wherein said base key is generated by a Diffie-Hellman key exchange effected between the first party and the second trusted entity.

13. A cryptographic key agreement method, comprising:
providing a first party with a first-party identifier-based public/private key pair generated in accordance with claim 1;
providing a second party with a second-party identifier-based public/private key pair generated in accordance with claim 1 using the same or a different trusted entity, the second party having an associated second-party identifier;
the first and second parties exchanging the public keys of their respective identifier-based key pairs;
the first and second parties effecting a Diffie Hellman exchange of key material; and
the first and second parties each generating an inter-party symmetric key by applying a one-way hash function to a deterministic combination of at least elements formed from the exchanged public keys and key material.

14. A method according to claim 13, wherein the identifier-based key pairs of the first and second parties are based on Schnorr signatures.

15. Apparatus for of generating an identifier-based public/private key pair for a first party, comprising:
a first computing arrangement associated with a trusted authority that has associated public values g, p, q, y and secret x where:
p and q are large primes satisfying q|p−1;
g is an integer such that g^{q}=1 mod p;
x is an integer such that 1<x<q; and
y=g^{x} mod p;
the first computing arrangement being arranged to use the secret x to compute a multi-component signature over an identifier of a first party; and
a second computing arrangement arranged to convert the signature into the first-party identifier-based key pair, the private key of this key pair comprising a first component of the signature provided as a secret to the first party, and the public key being formed using at least another component of the signature and said identifier.

16. Apparatus according to claim 15, wherein the second computing arrangement is also associated with the trusted authority.

17. Apparatus according to claim 15, wherein the second computing arrangement is associated with the first party.

18. Apparatus according to claim 15, wherein said signature is a Schnorr signature

19. Apparatus according to claim 18, wherein the first computing arrangement is arranged to compute the Schnorr signature over the first party identifier ID_{A} by:
choosing secret u at random in the range 0<u<q−1;
computing:
h_{A}=H₁(g^{u} mod p, ID_{A})
where H₁ is a one-way hash function applied to a deterministic combination of (g^{u} mod p) and ID_{A};
computing:
s_{A}=u−x*h_{A} mod q
where h_{A} and s_{A} constitute the signature components;
the second computing arrangement being arranged to convert the signature to the identifier-based key pair by using the component s_{A} as the private key and computing:
y_{A}=g^{s}^{_{A}} mod p
to complete the identifier-based public key ID_{A}, h_{A}, y_{A}

20. Apparatus according to claim 15, wherein said signature is a DSA signature.

21. Apparatus according to claim 20, wherein the first computing arrangement is arranged to compute the DSA signature over the first party identifier ID_{A} by:
choosing secret u at random in the range 0<u<q−1
computing:
h_{A}=H₂(ID_{A})
where H₂ is a one-way hash function
computing:
f_{A}=(g^{u} mod p) mod q
s_{A}=(u⁻¹)*(h_{A}+x*f_{A})) mod q
where f_{A} and s_{A} constitute the signature components;
the second computing arrangement being arranged to convert the signature to the identifier-based key pair by using the component s_{A} as the private key and computing:
v_{A}=((g^{(h}^{_{A}}^{/s}^{_{A}} ^{mod q)})*(y^{(f}^{_{A}}^{/s}^{_{A}} ^{mod q)})) mod p
to complete the identifier-based public key ID_{A}, v_{A}.

22. Apparatus according to claim 20, wherein the first computing arrangement is arranged to compute the DSA signature over the first party identifier ID_{A} by:
choosing secret u at random in the range 0<u<q−1
computing:
h_{A}=H₂(ID_{A})
where H₂ is a one-way hash function
computing:
v_{A}=g^{u} mod p
s_{A}=((u⁻¹)*(h_{A}+x*(v_{A} mod q))) mod q
where v_{A} and s_{A} constitute the signature components;
the second computing arrangement being arranged to convert the signature to the identifier-based key pair by using the component s_{A} as the private key, and the component v_{A} and identifier ID_{A} as the identifier-based public key.

23. A method of generating an identifier-based public/private key pair for a first party, comprising:
providing an identifier of the first party for use by a first trusted entity that has a secret the first trusted entity using its secret to compute a multi-component signature, based on discrete logarithms, over the first-party identifier; and
converting the signature into the first-party identifier-based key pair, the private key of this key pair comprising a first component of the signature provided confidentially to the first party, and the public key being formed using at least another component of the signature and said identifier.
